(19) United States
(12) Patent Application Publication
(10) Pub. No.: US 2011/0062705 A1
(43) Pub. Date: Mar. 17, 2011

(54) Pipe End Connecting Structure

(76) Inventors: Chong B. Wong, Vernon Hills, IL (US); Michael W. Davis, Elburn, IL (US)

(21) Appl. No.: 12/853,378

(22) Filed: Aug. 10, 2010

Related U.S. Application Data
(60) Provisional application No. 61/242,183, filed on Sep. 14, 2009.

(51) Int. Cl. F16L 25/00

(52) U.S. Cl. 285/320

(57) ABSTRACT

A pipe end connecting structure has a floater received in the end of a pipe with a head of the floater against the end of the pipe. A locking device connectable to another structure includes a portion inserted into the floater and locked thereto. The locking device restricts withdrawal of the floater from the pipe, and the floater restricts withdrawal of the locking device from the floater.

### CROSS-REFERENCE TO RELATED APPLICATIONS

The present application claims the benefits of U.S. Provisional Application Ser. No. 61/242,183 filed Sep. 14, 2009.

### FIELD OF THE INVENTION

The present invention relates generally to structures and assembly processes for making connections to cylindrical objects; and, more particularly, the invention relates to connections to pipes that can be made quickly and securely without the need for tools.

### BACKGROUND OF THE INVENTION

Connecting structures to the ends of cylindrical objects such as pipes can be difficult. Connecting a metal structure to a metal pipe can be accomplished by welding, brazing and other attaching techniques that can be difficult, time consuming and expensive. Connecting dissimilar materials can be difficult for various reasons, including identifying a technique suitable for both materials. Adhesives and other bonding agents are sometimes used. Many of the known methods require the use of tools or other process systems, multiple parts, long process times, expensive materials, procedures and equipment; or the like. In some assemblies that need to be provided at low cost, increased assembling efficiency can be a significant opportunity for cost reduction. Accordingly, it is desirable to provide a connecting structure with few parts for establishing a connection that can be completed without tools, extraneous processes or the like for connecting a structure to the end of a cylindrical object, such as a pipe.

### SUMMARY OF THE INVENTION

A connection to an end of a pipe includes a floater installed in the pipe and a locking device attached to or a part of the structure to be connected to the pipe. The floater includes legs secured in the pipe and a head at the end of the pipe. The head includes a shaped opening for receiving portions of the locking device inserted therethrough. The locking device is rotated to a locked position securing the floater in the pipe and the locking device in the floater.

In one aspect of one form thereof, a pipe end connecting structure is provided with a floater received in an end of a pipe, the floater having a deflectable protrusion for secure the floater in the pipe, and a floater head at the end of the pipe. The head has a shaped opening. The deflectable protrusion is deflectable to a deflected position for insertion into the pipe. A locking device has a locking head shaped for insertion into the shaped opening of the floater. The locking head is rotatable relative to the floater from a locking head position not limiting deflection of the deflectable protrusion to a second head position that limits deflection of the deflectable protrusion to the deflected position.

In another aspect of a form thereof, a pipe end connection is provided with a floater received in a pipe end and including a protrusion wider than an axial bore of the pipe, the protrusion engaging a hole in the side of the pipe. A locking device is received by the floater and is positionally adjustable from an inserted position to a locked position relative to the floater to inhibit withdrawal of the protrusion from the hole. An anti-rotation snap and a stop on the locking device and the floater are cooperatively associated to engage with one another and inhibit rotation from the locked position to the inserted position.

In a further aspect of a form thereof, a pipe end connection is provided for a pipe having an axial bore, an open end having an end edge, and a hole in the side thereof. A floater is secured in the axial bore, the floater having a head at the pipe open end and a deflectable leg in the pipe, the head defining a slot, and the deflectable leg having a protrusion received in the hole in the pipe. A locking device is received by and engaging the floater, the locking device having a wing inserted through the slot and rotated from the slot to a position against the deflectable leg.

An advantage of one form of a pipe end connecting structure is that a connection to the end of a pipe can be made manually, without the need for tools or complicated and expensive processes.

Another advantage of a form of a pipe end connecting structure is that a pipe and another object of dissimilar materials can be physically connected quickly and easily.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a perspective illustration of a pipe end connecting structure, with components to be connected aligned for connection, but not yet connected;

FIG. 2 is a perspective view, partially broken away; of a first step in completing the connection;

FIG. 3 is another perspective view, partially broken away, of the assembly in the condition shown in FIG. 2;

FIG. 4 is a partially broken away perspective illustration of the assembly following a step subsequent to those shown in the previous drawings;

FIG. 5 is an enlarged perspective illustration of the connected components, without the pipe being shown;

FIG. 6 is a perspective illustration of a pipe portion of the structure aligned for insertion into a steel pipe;

FIG. 7 is a perspective illustration after completing insertion of the pipe component into the pipe;

FIG. 8 is a perspective illustration of one part of the structure;

FIG. 9 is a perspective illustration of the part shown in FIG. 8 taken from a different angle;

FIG. 10 is a perspective view of another embodiment of the part shown in FIGS. 8 and 9;

FIG. 11 is a perspective view of the part shown in FIG. 10, shown from a different angle;

FIG. 12 is a perspective view of another part for the second embodiment;

FIG. 13 is an elevational view of the part shown in FIG. 12;

FIG. 14 is a side elevational view of the part shown in FIGS. 12 and 13;

FIG. 15 is an elevational view similar to that of FIG. 13, but showing the face of the part opposite the face shown in FIG. 13.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use herein of “including”, “comprising” and variations thereof is meant to encompass the items listed thereafter and equivalents thereof, as well as additional items and equivalents thereof.

### DETAILED DESCRIPTION OF THE PREFERRED EMBODIMENT

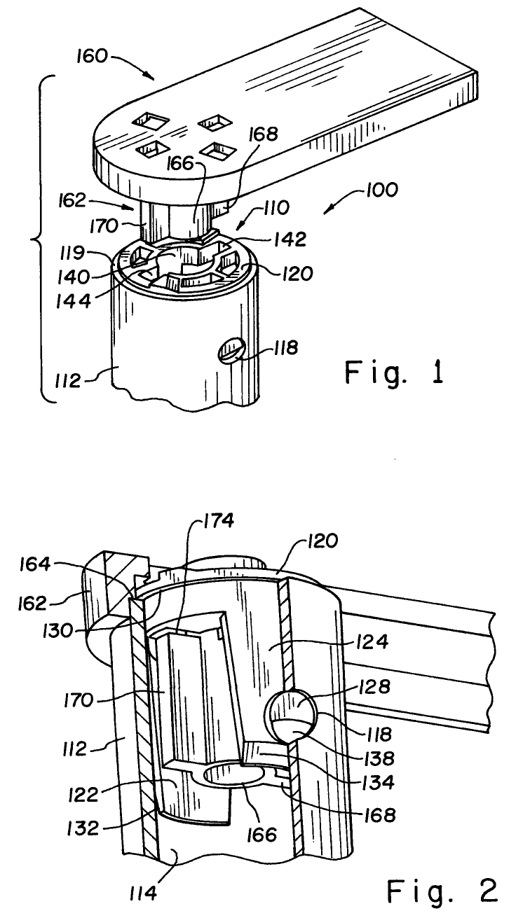

Referring now more particularly to the drawings, and to FIG. 1 in particular, a pipe end connecting structure 100 includes a floater 110 received in a pipe 112. Floater 110 can be made of plastic, and pipe 112 can be made of metal such as steel or other materials, including plastics. It should be understood that the connecting structure of the present invention can be used advantageously with a variety of different materials including various plastics and metals for each of the components to be described herein. The connecting structure can be used when various components are of different materials and when the various components are of similar materials.

Pipe 112 includes a cylindrical wall defining an axial bore 114 and first and second diametrically opposed holes 116, 118 near one end of pipe 112, spaced inwardly from an end edge 119 of pipe 112. Pipe 112 is open at the end thereof to which the connection is to be completed.

Floater 110 is received in and locker to pipe 112. Floater 110 includes a head 120 and axially extending, transversely curved first and second legs 122, 124 each having a protrusion 126, 128 respectively thereon. Head 120 defines a circumferential shoulder 130 of larger diameter than the diameter of axial bore 114 in pipe 112. The transverse curvature of legs 122, 124 corresponds to the curvature of axial bore 114 so that legs 122, 124 will fit against axial bore 114. Accordingly, floater 110 can be installed in the end of pipe 112 by inserting legs 122, 124 into axial bore 114. The dimensions of floater 110 and the structure of pipe 112 are selected so that protrusions 126, 128 are received in holes 116, 118 with circumferential shoulder 130 engaged against the distal end edge 119 of pipe 112. Legs 122, 124 are resiliently deflectable to bend inwardly slightly and rebound outwardly. During assembly, legs 122, 124 yield inwardly so that protrusions 128, 130 enter axial bore 114 and slide along the inner surface thereof. Floater 110 can be inserted into the end of pipe 112 without aligning protrusions 126, 128 with holes 116, 118. When floater 110 is fully inserted so that shoulder 130 is engaged against end edge 119, floater 110 can be rotated until protrusions 126, 128 align with and snap into holes 116 and 118 as legs 122, 124 rebound outwardly. To facilitate the insertion and necessary inward deflection of legs 122, 124 each of legs 122, 124 and protrusions 126, 128 can be provided with a ramp portion, angular lead-in surface 132, 134, 136, 138, respectively.

Head 120 defines an end opening therethrough, including a center aperture 140 and diametrically opposed slots 142, 144 contiguous with center aperture 140. Ramp stops 146, 148 are provided adjacent slots 142, 144, respectively, on the outer face of head 120. The outer surfaces of ramp stops 146, 148 adjacent slots 142, 144 define angular ramps 150, 152 terminating at rotation stoppers 154, 156 formed as substantially axially oriented surfaces.

In a completed assembly for pipe end connecting structure 100, a locking device 160 is connected to floater 110. It should be understood that locking device 160 can be a portion of a structure or device to be connected to the pipe, or can itself be in independent part connected to another object by suitable means. Locking device 160 is provided with a locking head 162 for engaging floater 110. Locking device 160 can be made of plastic, metals and other suitable materials either the same as or different from either floater 110 or pipe 112.

Locking head 162 defines an annular inner step or shoulder 164 to receive and surround floater head 120 and a circumferential outer portion of end edge 119 radially outward of shoulder 130 on floater 110. Accordingly, head 162 receives therein and surrounds an end portion of pipe 112 with floater 110 installed therein. Locking head 162 further includes a post 166 and wings 168, 170 configured and arranged to be inserted into center aperture 140 and opposed slots 142, 144, respectively. During assembly, post 166 and wings 168, 170 are inserted through aperture 140 and slots 142, 144 until shoulder 164 engages end edge 119 and floater head 120. FIGS. 1 and 2 illustrate, respectively, locking device 160 positioned for insertion and fully inserted.

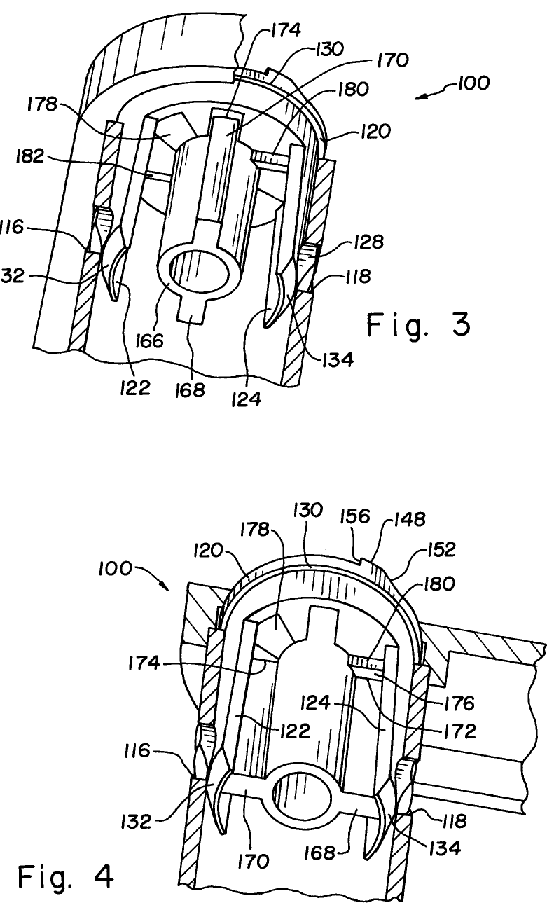

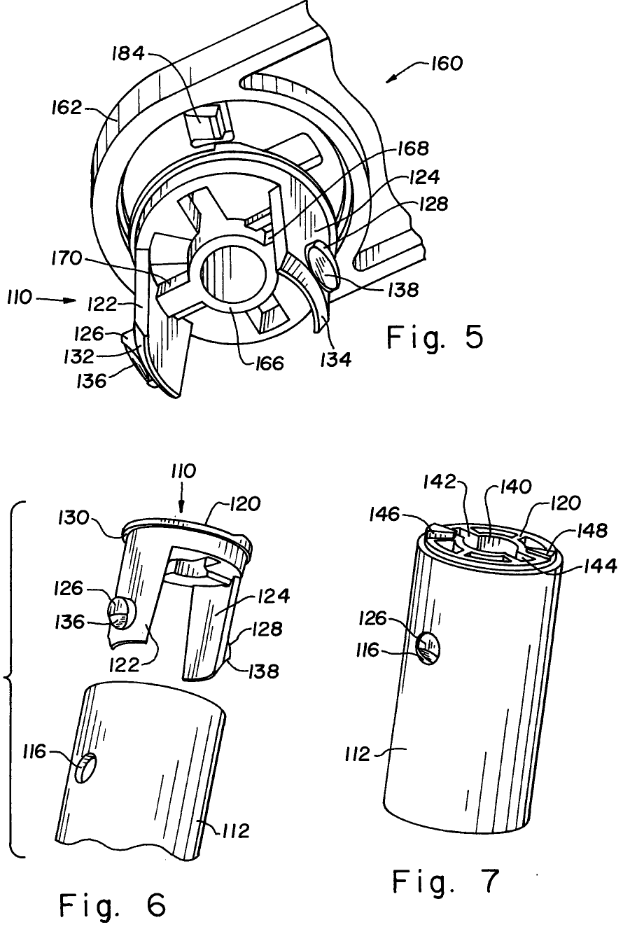

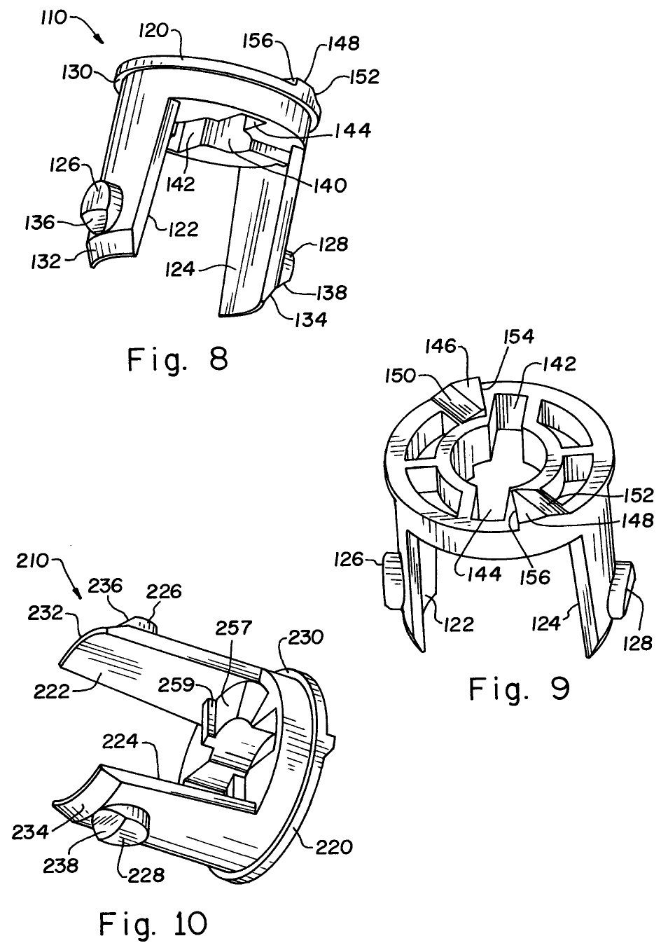

With reference now to FIGS. 3 and 4, it can be observed how the locking device of the present invention is locked to secure locking device 160 to both floater 110 and pipe 112. FIG. 3 illustrates from another angle the fully inserted position depicted in FIG. 2, with wings 168, 170 of locking device 160 within floater 110. From the position shown in FIG. 3, locking device 160 is rotated through some suitable distance, approximately 90° in the exemplary embodiment shown, so that wings 168, 170 are aligned with and radially inward of legs 122, 124. Proximal ends 172, 174 of wings 168, 170 ride against angular ramps 176, 178 on the inside of floater 110 to draw locking head 162 tightly against floater 110 and pipe 112. Rotation of locking device 160 relative to floater 110 is terminated when a stopper 180, 182 is encountered, depending on the direction that locking devices 160 is rotated relative to floater 110. Head 162 is further provided with one or more deflectable anti-rotation snap 184 for riding over ramps 150, 152 while deflecting outwardly and rebounding inwardly thereafter against stops 154, 156 of ramp stops 146, 148.

In the second, locked position of locking head 162, floater 110, pipe 112 and locking device 160 are compacted tightly together. Floater 110 is secured in pipe 112 by the engagement of protrusions 126, 128 in holes 116, 118. Floater 110 can not be dislodged easily from pipe 112 in that wings 168, 170 backed by post 166 there between are aligned between and against legs 122, 124 so that the legs cannot be deflected inwardly to disengage protrusions 126, 128 from holes 116, 118 in pipe 112. A continuous, structure is provided between legs 122, 124 via wings 168, 170 and post 166 there between. Locking device 160 is secured to floater 110 by the engagement of wing proximal ends 172, 174 against ramps 176, 178 so that locking device 160 can not be pulled outwardly away from floater 110. Rotation of locking device 160 away from the second, locked position toward the first, inserted position is inhibited by anti-rotation snap 184 lodged against either stop 154 or stop 156.

FIGS. 10 and 11 illustrate another embodiment of a floater 210. Structures and features of floater 210 that are similar to structures and features of floater 110 are identified with numbers in the “200” series corresponding to the numbers in the “100” series used for floater 110. Accordingly, floater 210 includes a head 220 and legs 222, 224 with protrusions 226, 228 which are similar to head 120, legs 122, 124 and protrusions 126, 128 of floater 110. Head 220 defines a circumferential shoulder 230 similar to circumferential shoulder 130. Angular lead-in surfaces 232, 234, 236, 238 are provided on legs 222, 224 and protrusions 226, 228. A center aperture 240 and diametrically opposed slots 242, 244 are provided in head 220. Ramp stops 246, 248 provided at the outer ends of slots 242, 244 are provided with angular ramps 250, 252 terminating at rotation stoppers 254, 256. The inside of head 220 defines engaging ramps 257 with stops 259, only one of which is visible in the drawings.

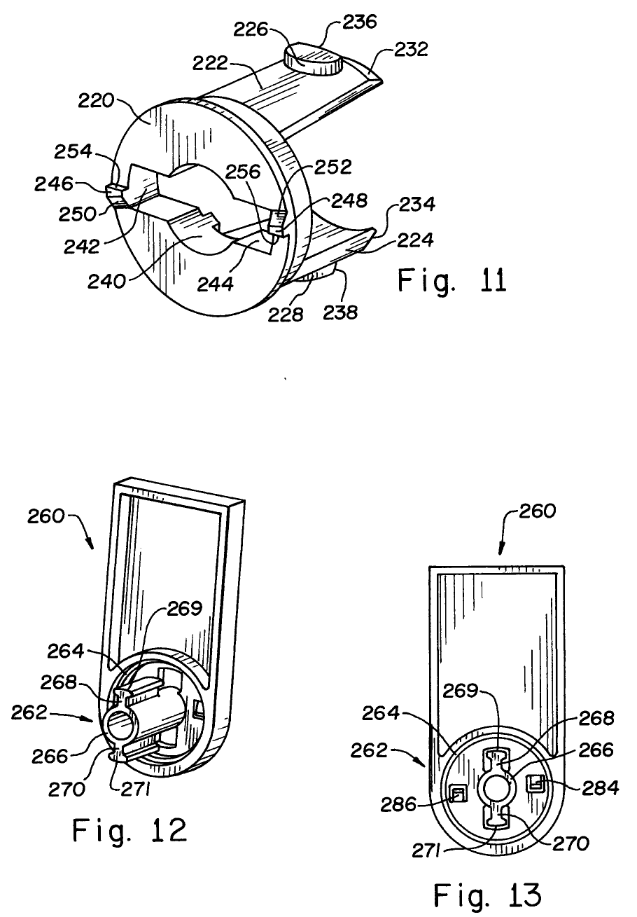

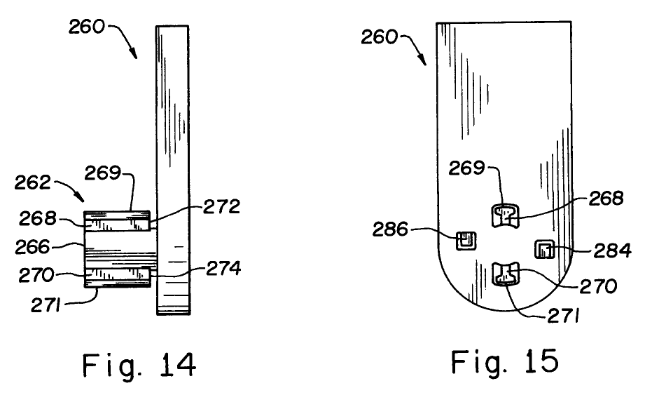

A locking device 260 (FIGS. 12-15) includes a locking head 262 defining an inner step or shoulder 264, a post 266 and wings 268, 270. Wings 268, 270 are T-shaped in cross section, having elongated outer portions 269, 271 respectively. Proximal ends 272, 274 of wings 268, 270 ride against angular engaging ramps 257. Head 262 is provided with two deflectable anti-rotation snaps 284, 286 for riding over ramps 250, 252 and engaging rotation stoppers 254, 256. The elongated outer surfaces of outer portions 269, 271 provide increased contact area against legs 222, 224.

The connecting structures and devices shown and described herein, including floaters 110, 210 and locking devices 160, 260 can be used for a variety of different purposes including simple physical attachment of a device or structure to a cylindrical object such as a pipe. However, those skilled in the art will readily understand that with the use of appropriate ports through the floater and locking device as well as gaskets or the like between mating components a connection can be made so as to transfer fluids between the pipe, locking device and another structure. The connections made can be accomplished easily by hand, without tools or complicated processes, and are suitable for use with components of a variety of different materials.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. A pipe end connecting structure, comprising:
a floater received in an end of a pipe, said floater having a deflectable protrusion for secure said floater in the pipe and a floater head at the end of the pipe, said head having a shaped opening;
said deflectable protrusion being deflectable to a deflected position for insertion into the pipe;
a locking device having a locking head shaped for insertion into said shaped opening of said floater; and
said locking head being rotatable relative to said floater from a locking head position not limiting deflection of said deflectable protrusion to a second head position that limits deflection of said deflectable protrusion to said deflected position.

2. The connecting structure of claim 1, said locking head including an annular shoulder engaging said head of said floater.

3. The connecting structure of claim 1, said floater having an aperture through said floater head and slots contiguous with said aperture.

4. The connecting structure of claim 3, said locking head including a post and wings insertable into said aperture and said slots.

5. The connecting structure of claim 4, said floater and said locking head having cooperating structures inhibiting relative rotation between said locking head and said floater away from said second head position.

6. The connecting structure of claim 4, said wings having exposed proximal ends movable beneath said floater head, and said floater head having ramps engaging said proximal ends of said wings for drawing said locking head and said floater toward one another upon relative rotation toward said second head position.

7. The connecting structure of claim 1, said floater having two deflectable legs and a deflectable protrusion on each said leg.

8. The connecting structure of claim 7, said floater having an aperture through said floater head and opposed slots contiguous with said aperture.

9. The connecting structure of claim 8, said locking head including a post and opposed wings insertable into said aperture and said slots.

10. The connecting structure of claim 9, said second locking head position having said wings aligned between said legs.

11. The connecting structure of claim 9, said wings having elongated outer portions engaged against said legs in said second head position.

12. The connecting structure of claim 1, said locking head including two anti-rotation snaps, and said floater including two stops engaging said anti-rotation snap in said second head position.

13. A pipe end connection, comprising:
a floater received in a pipe end and including a protrusion wider than an axial bore of the pipe, said protrusion engaging a hole in the side of the pipe;
a locking device received by the floater and being positionally adjustable from an inserted position to a locked position relative to the floater to inhibit withdrawal of the protrusion from the hole; and
an anti-rotation snap and a stop on said locking device and said floater cooperatively associated to engage with one another and inhibit rotation from said locked position to said inserted position.

14. The pipe end connection of claim 13, said floater having a head engaging an end edge of the pipe, and first and second legs extending from said head received in said pipe, each leg having a protrusion thereon extending into a hole in the pipe.

15. The pipe end connection of claim 14, said locking device having a post and opposed wings extending from said post; and said floater having an aperture with contiguous slots defined in said head, said aperture and said slots receiving said post and said wings in said inserted position.

16. The pipe end connection of claim 15, said wings having proximal ends engaging the inside of said floater in said locked position.

17. The pipe end connection of claim 16, said locking device having a locking head surrounding said floater head and the end of said pipe.

18. A pipe end connection, comprising:
a pipe having an axial bore, an open end having an end edge, and a hole in the side thereof;
a floater secured in said axial bore, said floater having a head at said pipe open end and a deflectable leg in said pipe, said head defining a slot, and said deflectable leg having a protrusion received in said hole in said pipe; and
a locking device received by and engaging said floater, said locking device having a wing inserted through said slot and rotated from said slot to a position against said deflectable leg.

19. The pipe end connection of claim 18, said pipe having two holes in the side thereof and said floater having first and second legs received in said pipe, each said leg having a protrusion received in one of said holes.

20. The pipe end connection of claim 19, said head of said floater defining first and second slots; and said locking device having first and second wings inserted through said first and second slots and rotated from said slots to positions against said first and second legs.

21. The pipe end connection of claim 9, said locking device having an anti-rotation snap engaging a stop on said floater in said rotated position.
